(19) United States
(12) Patent Application Publication
(10) Pub. No.: US 2023/0403618 A1
(43) Pub. Date: Dec. 14, 2023

(54) METHODS AND APPARATUS TO SUPPORT CONTROL PLANE LAYER-1/LAYER-2 INTER-CELL BEAM MANAGEMENT WITH MOBILITY

(71) Applicant: MediaTek Singapore Pte. Ltd., Singapore (SG)

(72) Inventors: Xiaonan Zhang, Beijing (CN); Yuanyuan Zhang, Beijing (CN)

(21) Appl. No.: 18/332,595

(22) Filed: Jun. 9, 2023

Related U.S. Application Data
(63) Continuation of application No. PCT/CN2022/097867, filed on Jun. 9, 2022.

(30) Foreign Application Priority Data
Jun. 9, 2022 (WO) PCT/CN2022/097867
May 12, 2023 (CN) 202310539701.1

(51) Int. Cl. H04W 36/08; H04W 36/00

(52) U.S. Cl. CPC H04W 36/08; H04W 36/0085; H04W 36/0058; H04W 36/0072

(57) ABSTRACT

Apparatus and methods are provided for control plane inter-cell beam management with mobility. In one novel aspect, UE receives a pre-configuration message from the base station before a cell switch command; performs L1 measurements based on the pre-configuration; and receives the cell switch command via MAC CE. The UE, after receiving the pre-configuration message, performs DL sync procedure and UL time alignment procedure before or after the cell switch command. In another novel aspect, the base station sends an RRC pre-configuration to UE including configuration for one or more candidate cells before a cell switch command; receives L1 measurement report for the one or more candidate cells from the UE; and sends the cell switch command to the UE carried in a MAC CE. In one embodiment, the base station keeps UE context of the UE after the UE switched to the one or more candidate cell.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2022/097867, titled “Methods and Apparatus To Support Layer-1/Layer-2 Inter-Cell Beam Management With Mobility,” with an international filing date of Jun. 9, 2022. This application claims priority under 35 U.S.C. § 119 from Chinese Application Number 202310539701.1, titled “METHODS AND APPARATUS TO SUPPORT CONTROL PLANE LAYER-1/LAYER-2 INTER-CELL BEAM MANAGEMENT WITH MOBILITY,” filed on May 12, 2023. The disclosure of each of the foregoing documents is incorporated herein by reference.

### TECHNICAL FIELD

The disclosed embodiments relate generally to wireless communication, and, more particularly, to control plane L1/L2 inter-cell beam management (ICBM) with mobility.

### BACKGROUND

In conventional network of 3rd generation partnership project (3GPP) 5G new radio (NR), when the UE moves from the coverage area of one cell to another cell, at some point a serving cell change needs to be performed. Currently serving cell change is triggered by layer three (L3) measurements and is done by radio resource control (RRC) reconfiguration signaling with synchronization for change of primary cell (PCell) and primary and secondary cell (PSCell), as well as release/add for secondary cells (SCells) when applicable. The cell switch procedures involve complete L2 (and L1) resets, which causes longer latency, larger overhead, and longer interruption time than beam switch mobility. To reduce the latency, overhead and interruption time during UE mobility, the mobility mechanism can be enhanced to enable a serving cell to change via beam management with L1/L2 signaling. The L1/L2 based inter-cell mobility with beam management should support the different scenarios, including intra-distributed unit (DU)/inter-DU inter-cell cell change, FR1/FR2, intra-frequency/inter-frequency, and source and target cells may be synchronized or non-synchronized.

In legacy handover (HO) design controlled by a series of L3 procedures including radio resource management (RRM) measurement and RRC Reconfiguration, ping-pong effects should be avoided with relatively long ToS (time of stay) in order to reduce the occurrences of HOs, accompanied with which is the reduce of signaling overhead and interruption during the overall lifetime of RRC connection. However, the drawback is that UE cannot achieve the optimized instantaneous throughput if the best beam does not belong to the serving cell. With the development of L1/L2-based inter-cell mobility with beam management, the cell switch can take advantage of the ping-pong effects to further improve the system performance.

Improvements and enhancements are required for control plane L1/L2 ICBM to take advantage of the ping pong effects.

### SUMMARY

Apparatus and methods are provided for control plane inter-cell beam management with mobility. In one novel aspect, the UE receives a pre-configuration message from the source DU with one or more candidate cells or a target cell before a cell switch command is received. The UE performs L1 measurements based on the pre-configuration and sends L1 measurement reports to the source DU. The UE, after receiving the pre-configuration message, performs downlink (DL) synchronization procedure and uplink (UL) time alignment procedure before or after receiving cell switch command. The UE subsequently receives a cell switch command via MAC CE. In one embodiment, the DL synchronization is performed upon receiving the pre-configuration message and before receiving the cell switch command carried in MAC CE. In another embodiment, the DL synchronization is performed after receiving the cell switch command carried in MAC CE. In one embodiment, the UL time alignment is performed upon receiving the pre-configuration message and before receiving the cell switch command carried in the MAC CE. In another embodiment, the UL time alignment is performed after receiving the cell switch command carried in the MAC CE. In one embodiment, the DL synchronization involves performing finer tracking and is performed based on the pre-configuration message. In another embodiment, the UL time alignment is performed through a random access (RA) procedure towards the one or more candidate cell. In one embodiment, the UL time alignment procedure is triggered by receiving a command from the source gNB of the wireless network to initiate the UL time alignment with the second cell or with the one or more candidate cells, or is triggered by detecting one or more conditions being satisfied based on the L1 measurement. In another embodiment, the UL time alignment is performed without an RA procedure when the UE obtained a timing advance group (TAG) of the second cell and a timing advance timer (TAT) associated with the second cell is running.

In another novel aspect, the base station/gNB-DU receives a pre-configuration message from a central unit (CU) in the wireless network, wherein the pre-configuration message includes configuration for one or more candidate cells, sends an RRC pre-configuration to the UE including the configuration for the one or more candidate cells before a cell switch command; receives L1 measurement reports for the one or more candidate cells from the UE; and subsequently, sends cell switch command to the UE carried in a MAC CE indicating a cell switch from a first cell to a second cell that belongs to the one or more candidate cells. In one embodiment, the cell switch is determined by the CU. In another embodiment, the cell switch is determined by the DU. In another embodiment, the source DU keeps UE context of the UE after the UE switched to the second cell.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary 5G new radio network in accordance with embodiments of the current invention.

FIG. 2A illustrates an exemplary NR wireless system with centralized upper layers of NR radio interface stacks in accordance with embodiments of the current invention.

FIG. 2B illustrates an exemplary diagram for top-level functions of the control plane L1/L2 inter-cell beam management with mobility in accordance with embodiments of the current invention.

FIG. 3 illustrates an exemplary deployment scenario for intra-DU inter-cell beam management in accordance with embodiments of the current invention.

FIG. 4 illustrates an exemplary deployment scenario for inter-DU inter-cell beam management in accordance with embodiments of the current invention.

FIG. 5 illustrates exemplary processes for UE to perform DL synchronization and UL time alignment before UE receiving the cell switch command.

FIG. 6 illustrates exemplary processes for UE to perform DL synchronization with target cell before UE receiving the cell switch command.

FIG. 7 illustrates exemplary processes for UE to perform UL time alignment and/or DL synchronization with target cell when UE receiving the cell switch command.

FIG. 8 illustrates an exemplary overall flow of inter-DU inter-cell beam management with source DU making cell switch decision in accordance with embodiments of the current invention.

FIG. 9 illustrates an exemplary overall flow of inter-DU inter-cell beam management with CU making cell switch decision in accordance with embodiments of the current invention.

FIG. 10 illustrates exemplary overall flows of inter-DU inter-cell beam management with source DU making cell switch decision with ping-pong effect in accordance with embodiments of the current invention.

FIG. 11 illustrates exemplary overall flows of inter-DU inter-cell beam management with CU making cell switch decision with ping-pong effect in accordance with embodiments of the current invention.

FIG. 12 illustrates an exemplary flow chart for the UE performing the control plane L1 ICBM with mobility in accordance with embodiments of the current invention.

FIG. 13 illustrates an exemplary flow chart for the gNB/gNB-DU performing the control plane L1 ICBM with mobility in accordance with embodiments of the current invention.

### DETAILED DESCRIPTION

Reference will now be made in detail to some embodiments of the invention, examples of which are illustrated in the accompanying drawings.

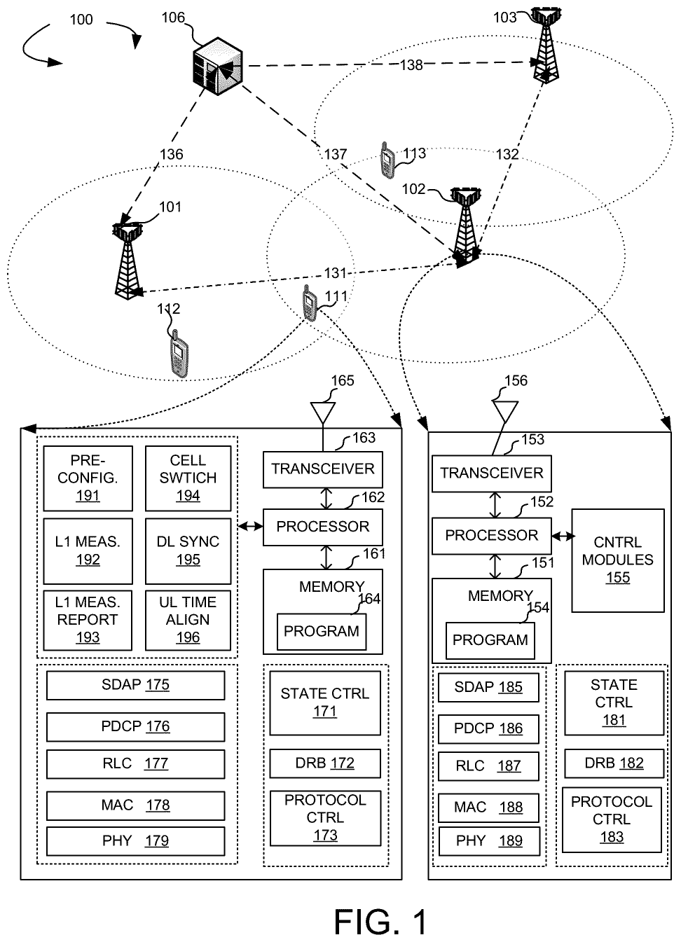

FIG. 1 is a schematic system diagram illustrating an exemplary 5G new radio (NR) network in accordance with embodiments of the current invention. Wireless system 100 includes one or more fixed base infrastructure units forming a network distributed over a geographical region. As an example, base stations/gNBs 101, 102, and 103 serve a number of mobile stations, such as UE 111, 112, and 113, within a serving area, for example, a cell, or within a cell sector. In some systems, one or more base stations are coupled to a controller forming an access network that is coupled to one or more core networks, through a network entity, such as network entity 106. gNB 101, gNB 102 and gNB 103 are base stations in NR, the serving area of which may or may not overlap with each other. As an example, UE or mobile station 112 is only in the service area of gNB 101 and connected with gNB 101. UE 112 is connected with gNB 101 only. UE 111 is in the overlapping service area of gNB 101 and gNB 102 and may switch back and forth between gNB 101 and gNB 102. UE 113 is in the overlapping service area of gNB 102 and gNB 103 and may switch back and forth between gNB 102 and gNB 103. Base stations, such as gNB 101, 102, and 103 are connected the network through network entities, such as network entity 106 through connections, such as 136, 137, and 138, respectively. Backhaul connections, such as Xn connections 131 and 132 connect non-co-located receiving base units. Xn connection 131 connects gNB 101 and gNB 102. Xn connection 132 connects gNB 102 and gNB 103. These backhaul connections can be either ideal or non-ideal.

When the UE, such as UE 111, is in the overlapping area, L1/L2-based inter-cell mobility is performed. For L1/L2 based inter-cell mobility with beam management, the network can take advantage of ping-pong effects, i.e., cell switch back and forth between the source and target cell, to select the best beams among a wider area including both the source cell and target cell for throughput boosting during UE mobility. L1/L2 based inter-cell mobility is more proper for the scenarios of intra-DU and inter-DU cell change. Ping-pong effect is not concerned in those scenarios. For intra-DU cell change, there is no additional signaling/latency needed at the network side; for inter-DU cell change, the F1 interface between DU and CU can support high data rate with short latency. L1/L2 based inter-cell mobility is supportable considering the F1 latency is 5 ms. During L1/L2 based inter-cell mobility, DL synchronization and UL time alignment are required with the corresponding serving cell. By default, DL synchronization and UL time alignment are preformed after the handover command is received. Considering the performance requirement of inter-cell beam management, A method to perform DL synchronization and UL time alignment before beam management is introduced to reduce the data interruption time (DIT) during inter-cell beam management. For the scenario of UE switches back and forth between cells, a method to control TA maintenance is further introduced to reduce the DIT during inter-cell beam management.

In one novel aspect, the UE receives a pre-configuration message from the network without cell switch indication. A cell switch command in MAC CE is received subsequently for the UE to perform inter-DU cell switch. The UE performs L1/L2 measurements after receiving the pre-configuration message. The DL sync procedure and UL time alignment procedure is performed after receiving the pre-configuration message. The DL sync procedure and UL time alignment procedure is performed before or after receiving the cell switch command from the network.

FIG. 1 further illustrates simplified block diagrams of a base station and a mobile device/UE for data/control transmissions. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations. In one novel aspect, control module 155 is configured to receive a pre-configuration message from a central unit (CU) in the wireless network, wherein the pre-configuration message includes configuration for one or more candidate cells; send an RRC pre-configuration to a user equipment (UE) including configurations for the one or more candidate cells before a cell switch command; receive L1 measurement reports for the one or more candidate cells from the UE; and send the cell switch command to the UE carried in a MAC control element (CE) indicating a cell switch from a first cell to a second cell that belongs to the one or more candidate cells. An RRC state controller 181 performs access control for the UE. A DRB controller 182 performs control function to establish/add, reconfigure/modify, and release/remove a DRB based on different sets of conditions for DRB establishment, reconfiguration and release. A protocol stack controller 183 manages to add, modify or remove the protocol stack for the DRB. The protocol Stack includes SDAP layer 185, PDCP layer 186, RLC layer 187, MAC layer 188 and PHY layer 189.

UE 111 has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown) for different frequency bands. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 102.

UE 111 also includes a set of control modules that carry out functional tasks. These control modules can be implemented by circuits, software, firmware, or a combination of them. An RRC State controller 171 controls UE RRC state according to network's command and UE conditions. UE supports the following RRC states, RRC_IDLE, RRC_CONNECTED and RRC_INACTIVE. A DRB controller 172 controls to establish/add, reconfigure/modify and release/remove a DRB based on different sets of conditions for DRB establishment, reconfiguration and release. A protocol stack controller 173 manages to add, modify or remove the protocol stack for the DRB. The protocol Stack includes SDAP layer 175, PDCP layer 176, RLC layer 177, MAC layer 178 and PHY layer 179. A pre-configuration module 191 receives a pre-configuration radio resource control (RRC) message from a first gNB in a wireless network before a cell switch command, wherein the pre-configuration message includes configurations for one or more candidate cells, and wherein the UE connected with a first cell. A L1 measurement module 192 performs L1 measurements for the one or more candidate cells based on the pre-configuration message. A L1 measurement report module 193 sends an L1 measurement report to the gNB. A cell switch module 194 receives a subsequent cell switch command carried in a MAC control element (CE) indicating to switch from a first cell to a second cell, wherein the second cell is one of the one or more candidate cells indicated in the pre-configuration message. A DL sync module 195 performs a DL synchronization towards one or more candidate cells. An UL time alignment module 196 performs an UL time alignment with one or more candidate cell.

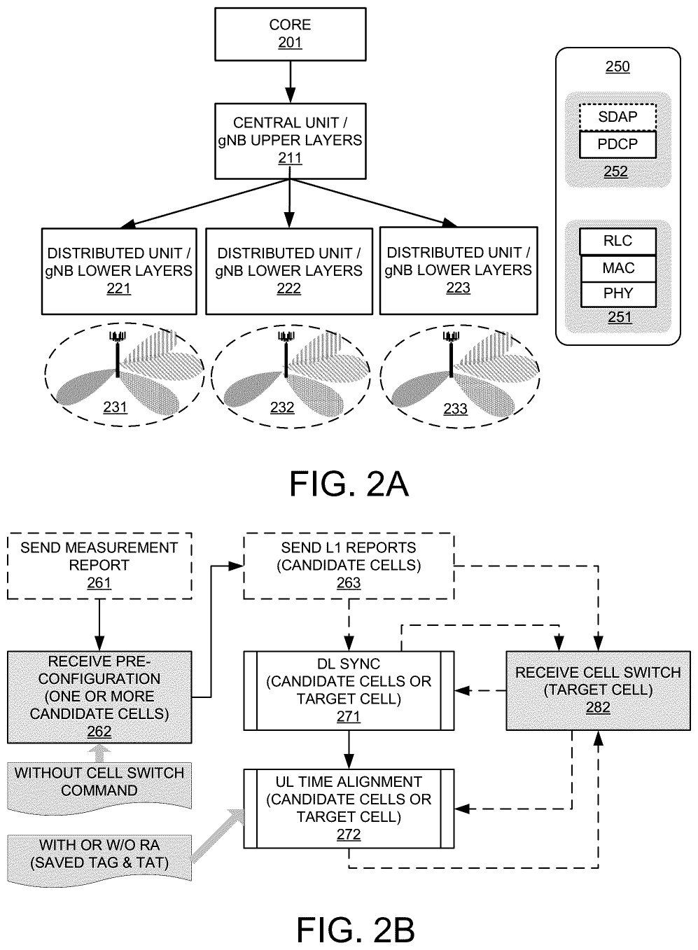

FIG. 2A illustrates an exemplary NR wireless system with centralized upper layers of NR radio interface stacks in accordance with embodiments of the current invention. Different protocol split options between central unit (CU) and distributed unit (DU) of gNB nodes may be possible. The functional split between the CU and DU of gNB nodes may depend on transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221 with gNB lower layer 251. Distributed units 221, 222, and 223 each corresponds to a cell 231, 232, and 233, respectively. The DUs, such as 221, 222 and 223 include gNB lower layers 251. In one embodiment, gNB lower layers 251 include the PHY, MAC and the RLC layers.

FIG. 2B illustrates an exemplary diagram for top-level functions of the control plane L1/L2 inter-cell beam management with mobility in accordance with embodiments of the current invention. At step 261, the UE sends measurement reports to the network. At step 262, the UE receives pre-configuration message from the network. The pre-configuration message is received in an RRC message, which includes one or more candidate cells configuration. The pre-configuration message with candidate cells does not have the cell switch command. At step 263, the UE performs L1 measurement on the one or more candidate cells based on the pre-configuration message. Subsequently, at step 282, a cell switch command is received with the target cell in MAC CE. At step 271, after receiving the pre-configuration message, the UE performs DL sync procedure on the candidate cells when the cell switch command is not received. In another embodiment, the DL sync procedure is performed on the target cell when/after the cell switch command is received. At step 272, after receiving the pre-configuration message, the UE performs UL time alignment procedure on the candidate cells when the cell switch command is not received. In another embodiment, the UL time alignment procedure is performed on the target cell when the cell switch command is received.

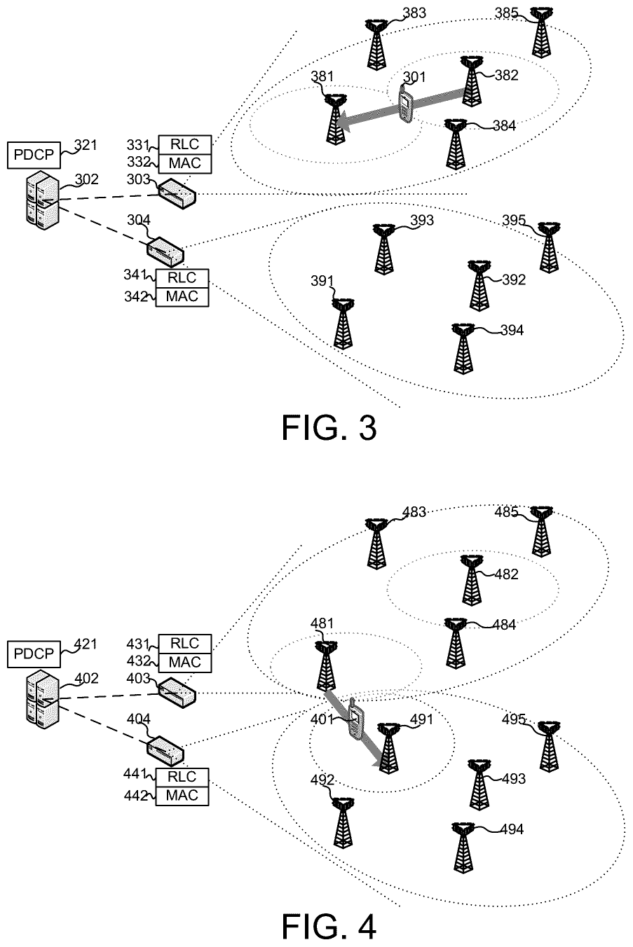

FIG. 3 illustrates an exemplary deployment scenario for intra-DU inter-cell beam management in accordance with embodiments of the current invention. A CU 302 is connected to two DUs, DU 303 and 304 through the F1 interface. CU 302 includes protocol stack PDCP 321. DU 303 includes protocol stack RLC 331 and MAC 332. DU 304 includes protocol stack RLC 341 and MAC 342. DU 303 and DU 304 are connected to multiple radio units (RUs) respectively. A cell may consist of a range covered by one or more RUs under the same DU. RUs/gNBs 381, 382, 383, 384, and 385 are connected with DU 303. RUs/gNBs 391, 392, 393, 394, and 395 are connected with DU 304. In this scenario, a UE 301 is moving from the edge of one cell served by gNB 382 to another cell served by gNB 381, which two belong to the same DU and share a common protocol stack. Intra-DU inter-cell beam management can be used in this scenario to replace the legacy handover process to reduce the interruption and improve the throughput of UE. In one embodiment, single protocol stack at the UE side (common RLC and/or MAC) is used to handle L1/L2 inter-cell beam management with mobility.

FIG. 4 illustrates an exemplary deployment scenario for inter-DU inter-cell beam management in accordance with embodiments of the current invention. A CU 402 is connected to two DUs, DU 403 and DU 404 through the F1 interface. CU 402 includes protocol stack PDCP 421. DU 403 includes protocol stack RLC 431 and MAC 432. DU 404 includes protocol stack RLC 441 and MAC 442. DU 403 and DU 404 are connected to multiple RUs respectively. A cell may consist of a range covered by one or more RUs under the same DU. RUs/gNBs 481, 482, 483, 484, and 485 are connected with DU 403. RUs/gNBs 491, 492, 493, 494, and 495 are connected with DU 404. In this scenario, a UE 401 is moving from the edge of one cell served by gNB 481 to another cell served by gNB 491, which belong to different DUs, DU 403 and DU 404, respectively, and share a common CU 402. The low layer user plane (RLC, MAC) is different in two DUs while high layer (PDCP) remains the same. Inter-DU inter-cell beam management can be used in this scenario to replace the legacy handover process to reduce the interruption and improve the throughput of UE. In one embodiment, single protocol stack at the UE side (common RLC and/or MAC) is used to handle L1/L2 inter-cell beam management with mobility. In one embodiment, dual protocol stack at the UE side (separate RLC and/or MAC) are used to handle L1/L2 inter-cell beam management with mobility.

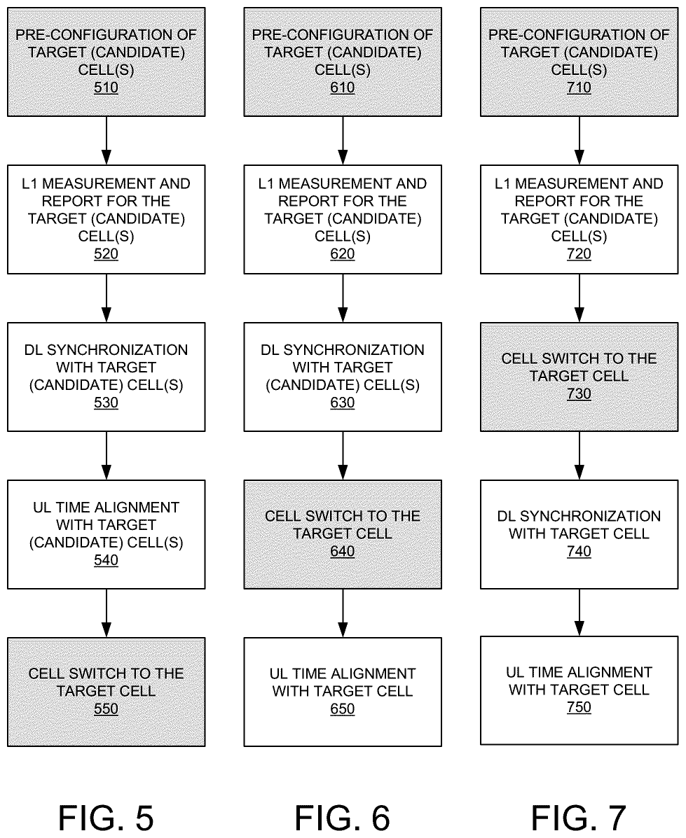

FIG. 5 illustrates exemplary processes for UE to perform DL synchronization and UL time alignment before UE receiving the cell switch command. For the pre-configuration of cell switch, UE sends MeasurementReport messages to the gNB. At step 510, the UE received RRC message which indicate UE to perform pre-configuration. In one embodiment, the pre-configuration message contains the target cell configuration. In one embodiment, the pre-configuration message contains one or multiple candidate cells configuration. The UE performs RRC signal processing and stores the pre-configuration to prepare for the cell switch. In one embodiment, UE applies the configuration for the prepared target cell or one or more candidate cells after RRC signaling processing. In one embodiment, the UE applies the configuration for the target cell upon reception of the cell switch command. In one embodiment, UE have the capability to perform RF/baseband retuning without interruption for the reception from the source cell. At step 520, the UE sends L1 measurement report for the target cell or the one or more candidate cells. In one embodiment, at step 530, the UE performs DL synchronization (530) and performs UL time alignment with the target cell before receiving the cell switch command (540).

In one embodiment, after pre-configuration (510), UE performs DL synchronization (530) with the target cell or one or more candidate cells. At step 520, subsequently, the UE starts L1 measurement and report for both serving cell and target/candidate cells. In one embodiment, for DL synchronization, UE performs fine tracking and acquires full timing information from the network. In one embodiment, the UL time alignment with the target cell (540) is performed through random access (RA). In one embodiment, the UL time alignment is triggered by network command. When UE receives the network command to acquire UL TA with the target cell, UE performs random access towards the target cell. In another embodiment, the UL time alignment is triggered by UE itself based on certain conditions. In one embodiment, the condition is based on the UE L1 measurements. In one embodiment, the condition is that the measurement result of the target cell is above a threshold, which is configured by the network. In one embodiment, the UL time alignment with one or multiple candidate cells is performed through one or multiple random access procedures and is triggered by the source DU of the network. Finally, at step 550, the UE receives the cell switch command. Since both DL synchronization and UL synchronization are available for the target cell, UE can switch to the target cell directly and starts data transmission/reception with the target cell.

FIG. 6 illustrates exemplary processes for UE to perform DL synchronization with target cell before UE receiving the cell switch command. For the pre-configuration of cell switch, UE sends MeasurementReport messages to the gNB. At step 610, the UE receives RRC message which indicates UE to perform pre-configuration. In one embodiment, the pre-configuration message contains the target cell configuration. In one embodiment, the pre-configuration message contains one or multiple candidate cells configuration. The UE performs RRC signal processing and stores the pre-configuration to prepare for the cell switch. After pre-configuration, at step 630, the UE performs DL synchronization towards the target cell or one or multiple candidate cells. At step 620, the UE starts L1 measurement and reports for both serving cell and target/candidate cells. Based on those measurement reports, the network decides when to perform cell switch and switch to which cell if multiple candidate cells are configured. Upon reception of the cell switch command at step 640, the UL time alignment through random access procedure is triggered. At step 650, the UE performs UL time alignment with the target cell. In one embodiment, the UE starts random access procedure to acquire UL time alignment with the target cell. In another embodiment, when the UE determines that the UE maintains a valid TAG for the target cell and the TAT associated with the target cell is still running, the UE skips the RA procedure.

FIG. 7 illustrates exemplary processes for UE to perform UL time alignment and/or DL synchronization with target cell when UE receiving the cell switch command. For the pre-configuration of cell switch, UE sends MeasurementReport messages to the gNB. At step 710, the UE received RRC message which indicate UE to perform pre-configuration. In one embodiment, the pre-configuration message contains the target cell configuration. In one embodiment, the pre-configuration message contains one or multiple candidate cells configuration. The UE performs RRC signal processing and stores the pre-configuration to prepare for the cell switch. In one embodiment, UE applies the configuration for the prepared target cell or one or more candidate cells after RRC signaling processing. In one embodiment, UE applies the configuration for the target cell upon reception of the cell switch command. In one embodiment, UE have the capability to perform RF/baseband retuning without interruption for the reception from the source cell. After pre-configuration, at step 720, the UE starts L1 measurement and report for both serving cell and target/candidate cells. Based on those measurement reports, the network decides when to perform cell switch and switch to which cell if multiple candidate cells are configured. Upon reception of the cell switch command, UE starts to perform DL synchronization with the target cell (740). At step 750, the UE performs UL alignment with the target cell. In one embodiment, random access procedure is triggered to acquire UL time alignment with the target cell. In another embodiment, when the UE determines that the UE maintains a valid TAG for the target cell and the TAT associated with the target cell is still running, the UE skips the RA procedure.

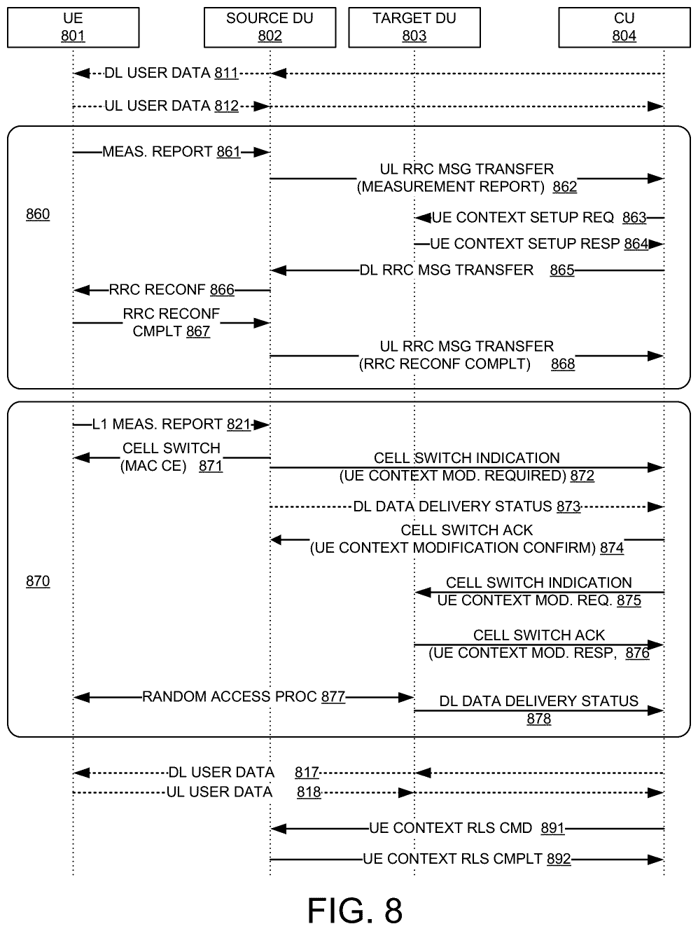

FIG. 8 illustrates an exemplary overall flow of inter-DU inter-cell beam management with source DU making cell switch decision in accordance with embodiments of the current invention. UE 801 is connected with the wireless network through a source DU 802 and CU 804. A neighboring cell is served with a target DU 803. At step 811, DL user data is transmitted through CU 804 to source DU 802 and to UE 801. At step 812, UL user data is sent from UE 801 to DU 802 and to CU 804. Pre-configuration 860 is provided first by network before the inter-cell beam management is executed. At step 861, UE 801 sends measurement reports to source DU 802. Source DU 802, at step 862, transfers the measurement report through UL RRC MESSAGE TRANSFER to CU 804. In one embodiment, source DU 802 sends an UL RRC MESSAGE TRANSFER message to the CU 804 to convey the received MeasurementReport message. At step 863, CU 804 sends a UE CONTEXT SETUP REQUEST message to the target DU 803 to create an UE context and setup one or more data bearers. At step 864, target DU 803 responds to the CU 804 with a UE CONTEXT SETUP RESPONSE message. At step 865, CU 804 sends a DL RRC MESSAGE TRANSFER message to the source DU 802, which includes the pre-configuration message to UE 801. At step 866, source DU 802 forwards the received pre-configuration message to UE 801 to indicate pre-configuration for the target cell or one or multiple candidate cells. In one embodiment, the pre-configuration message is delivered by RRCReconfiguration message. At step 867, UE 801 responds to source DU 802 with an RRCReconfigurationComplete message. At step 868, source DU 802 forwards the RRC configuration complete message to CU 804 via an UL RRC MESSAGE TRANSFER message.

Cell Switch procedure 870 is performed after the pre-configuration procedure 860. In one embodiment, the source DU makes the cell switch decision. At step 821, UE 801 starts performing L1 measurements and sending L1 measurement report for the candidate cells or the target cell to the source DU 802. At step 871, source DU 802 indicates cell switch command to UE 801 to trigger the cell switch procedure according to the L1 measurement report from UE 801. At step 872, source DU 802 send a message to CU 804 to indicate the cell switch to the target cell. In one embodiment, a UE CONTEXT MODIFICATION REQUIRED message is used to take the cell switch command. At step 873, source DU 802 also sends a Downlink Data Delivery Status frame to inform CU 804 about the unsuccessfully transmitted downlink data to the UE. At step 874, CU 804 sends cell switch ACK to the source DU 802 to indicate cell switch acknowledgement. In one embodiment, the message is delivered by UE CONTEXT MODIFICATION CONFIRM. At step 875, CU 804 sends a cell switch indication to target DU 803. In one embodiment, the message is delivered by UE CONTEXT MODIFICATION REQUEST. At step 876, target DU 803 responds cell switch ACK to the gNB-CU. In one embodiment, the message is delivered by UE CONTEXT MODIFICATION RESPONSE. At step 877, the RA procedure is performed at the target DU 803. At step 878, target DU 803 sends a Downlink Data Delivery Status frame to inform the CU 804.

UE 801 now switches to target DU 803. At step 817, Downlink packets, which may include PDCP PDUs not successfully transmitted in the source DU 802, are sent from the CU 804 to the target DU 803. In one embodiment, the target DU 803 also sends an ACCESS SUCCESS message to inform CU 804 of which cell the UE has successfully accessed. At step 818, UL user data is sent from UE 801 to target DU 803 and to CU 804. Finally, when CU 804 decides to release the source cell/DU, e.g., when UE moves away from the source cell, at step 891 the CU 804 sends a UE CONTEXT RELEASE COMMAND message to the source DU 802. At step 892, source DU 802 releases the UE context and responds to CU 804 with a UE CONTEXT RELEASE COMPLETE message.

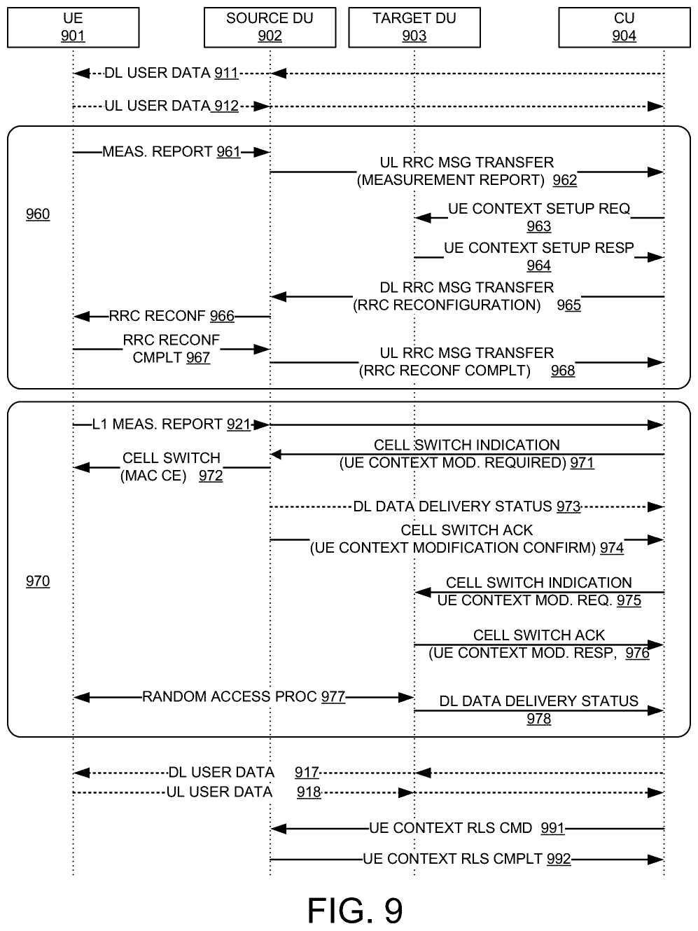

FIG. 9 illustrates an exemplary overall flow of inter-DU inter-cell beam management with CU making cell switch decision in accordance with embodiments of the current invention. UE 901 is connected with the wireless network through a source DU 902 and CU 904. A neighboring cell is served with a target DU 903. At step 911, DL user data is transmitted through CU 904 to source DU 902 and to UE 901. At step 912, uplink (UL) user data is sent from UE 901 to DU 902 and to CU 904. Pre-configuration 960 is provided first by network before the inter-cell beam management is executed. At step 961, UE 901 sends measurement reports to source DU 902. Source DU 902, at step 962, transfers the measurement report through UL RRC MESSAGE TRANSFER to CU 904. In one embodiment, source DU 902 sends an UL RRC MESSAGE TRANSFER message to the CU 904 to convey the received MeasurementReport message. At step 963, CU 904 sends a UE CONTEXT SETUP REQUEST message to the target DU 903 to create a UE context and setup one or more data bearers. At step 964, target DU 903 responds to the CU 904 with a UE CONTEXT SETUP RESPONSE message. At step 965, CU 904 sends a DL RRC MESSAGE TRANSFER message to the source DU 902, which includes the pre-configuration message to UE 901. At step 966, source DU 902 forwards the received pre-configuration message to UE 901 to indicate pre-configuration for the target cell or one or multiple candidate cells. In one embodiment, the message is delivered by RRCReconfiguration message. At step 967, UE 901 responds to source DU 902 with an RRCReconfigurationComplete message. At step 968, source DU 902 forwards the RRC configuration complete message to CU 904 via an UL RRC MESSAGE TRANSFER message.

Cell Switch procedure 970 is performed after the pre-configuration procedure 960. In one embodiment, the CU makes the cell switch decision. At step 921, UE 901 starts performing L1 measurements and sending L1 measurement report for the candidate cells or the target cell to the source DU 902. In one embodiment, source DU 902 forwards the L1 measurement reports to CU 904. At step 971, CU 904 detects the cell switch is fulfilled according to the L1 measurement report, then sends cell switch indication to source DU 902. In one embodiment, the message is delivered by UE CONTEXT MODIFICATION REQUIRED. CU 904 sends a UE CONTEXT MODIFICATION REQUEST message to the source DU 902 and indicates to stop the data transmission for the UE 901. At step 972, source DU 902 sends the cell switch command to UE 901 to indicate cell switch to the target cell. In one embodiment, the message is delivered by MAC CE. At step 973, source DU 902 also sends a Downlink Data Delivery Status frame to inform CU 904 about the unsuccessfully transmitted downlink data to the UE 901. At step 974, source DU 902 sends cell switch ACK to CU 904 to indicate cell switch acknowledgement. In one embodiment, the message is delivered by UE CONTEXT MODIFICATION CONFIRM. At step 975, CU 904 sends a cell switch indication to target DU 903. In one embodiment, the message is delivered by UE CONTEXT MODIFICATION REQUEST. At step 976, target DU 903 responds cell switch ACK to the CU 904. In one embodiment, the message is delivered by UE CONTEXT MODIFICATION RESPONSE. At step 977, the RA procedure is performed at the target DU 903. At step 978, target DU 903 sends a Downlink Data Delivery Status frame to inform the CU 904.

UE 901 now switches to target DU 903. At step 917, Downlink packets, which may include PDCP PDUs not successfully transmitted in the source DU 902, are sent from the CU 904 to the target DU 903 and to UE 901. In one embodiment, the target DU 903 also sends an ACCESS SUCCESS message to inform CU 904 of which cell the UE has successfully accessed. At step 918, UL user data is sent from UE 901 to target DU 903 and to CU 904. Finally, when CU 904 decides to release the source cell/DU, e.g., when UE moves away from the source cell, at step 991 the CU 904 sends a UE CONTEXT RELEASE COMMAND message to the source DU 902. At step 992, source DU 902 releases the UE context and responds CU 904 with a UE CONTEXT RELEASE COMPLETE message.

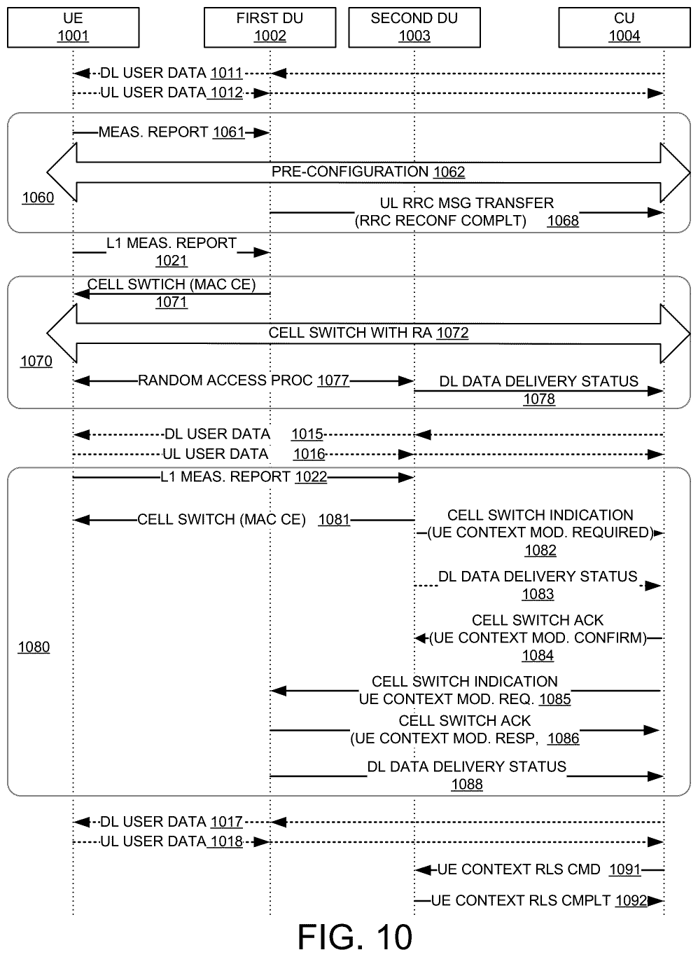

FIG. 10 illustrates exemplary overall flows of inter-DU inter-cell beam management with source DU making cell switch decision with ping-pong effect in accordance with embodiments of the current invention. In one embodiment, to take advantage of the ping pong effect, the source DU will not release the UE context. The UE maintains source DU information, such as the TAG and keeps the associated TAT running. The RA procedure is skipped when switching back to the prior cell with valid information. For the case of source DU making cell switch decision, the UE context will not be released by the source DU after UE switched to target cell. When TOS is short, UE may be switched back and forth between the two DUs, called the first DU and the second DU. At the very beginning, the UE is served by the first DU. The first DU is the source DU and the second DU is the target DU. Then UE is switched to the second DU. UE may be switched back to the first DU due to ping-pong effect. In this case, the second DU is the source DU and the first DU is the target DU.

UE 1001 is connected with the wireless network through a first DU 1002 and CU 1004. A neighboring cell is served with a second DU 1003. At step 1011, DL user data is transmitted through CU 1004 to first DU 1002 and to UE 1001. At step 1012, UL user data is sent from UE 1001 to first DU 1002 and to CU 1004.

Pre-configuration 1060 is provided first by network before the inter-cell beam management is executed. At step 1061, UE 1001 sends measurement report to first DU 1002. Pre-configuration procedure 1062 is similar/the same as steps from 862-867 wherein pre-configuration is performed. At step 1068, first DU 1002 forwards the RRC reconfiguration complete message to CU 1004 via an UL RRC MESSAGE TRANSFER message.

Cell Switch procedure 1070 is performed after the pre-configuration procedure 1060. In one embodiment, the source DU makes the cell switch decision. At step 1021, UE 1001 starts performing L1 measurements and sending L1 measurement report for the candidate cells or the target cell to first DU 1002. At step 1071, first DU 1002 indicates cell switch command to UE 1001 to trigger the cell switch procedure according to the L1 measurement report from UE 1001. Cell switch with RA procedure 1072 is similar/the same as steps from 872-876. At step 1077, the RA procedure is performed at second DU 1003. At step 1078, second DU 1003 sends a Downlink Data Delivery Status frame to inform the CU 1004.

UE 1001 now switches to second DU 1003. At step 1015, Downlink packets, which may include PDCP PDUs not successfully transmitted in first DU 1002, are sent from the CU 1004 to the second DU 1003 and to UE 1001. In one embodiment, the second DU 1003 also sends an ACCESS SUCCESS message to inform CU 1004 of which cell the UE has successfully accessed. At step 1016, UL user data is sent from UE 1001 to second DU 1003 and to CU 1004.

A switch back procedure, the cell switch procedure 1080 is performed with ping-pong effect. In one embodiment, once the UE switches to second DU 1003, first DU 1002 does not release the UE context. At step 1022, UE 1001 sends L1 measurement report to second DU 1003. At step 1081, second DU 1003 indicates cell switch command to UE 1001 to trigger the cell switch procedure according to the L1 measurement report from UE 1001. At step 1082, second DU 1003 sends a message to CU 1004 to indicate the cell switch to the target cell. In one embodiment, a UE CONTEXT MODIFICATION REQUIRED message is used to take the cell switch command. At step 1083, second DU 1003 also sends a Downlink Data Delivery Status frame to inform CU 1004 about the unsuccessfully transmitted downlink data to the UE. At step 1084, CU 1004 sends cell switch ACK to the second DU 1003 to indicate cell switch acknowledgement. In one embodiment, the message is delivered by UE CONTEXT MODIFICATION CONFIRM. At step 1085, CU 1004 sends a cell switch indication to first DU 1002. In one embodiment, the message is delivered by UE CONTEXT MODIFICATION REQUEST. At step 1086, first DU 1002 responds to the cell switch ACK to the CU 1004. In one embodiment, the message is delivered by UE CONTEXT MODIFICATION RESPONSE. Since first DU 1002 still have UE context and UE 1001 maintains first DU 1002 information, the RA procedure is skipped. At step 1088, first DU 1002 sends a Downlink Data Delivery Status frame to inform the CU 1004.

UE 1001 now switches back to first DU 1002. At step 1017, downlink packets, which may include PDCP PDUs not successfully transmitted in second Du 1003, are sent from the CU 1004 to the first DU 1002. In one embodiment, the first DU 1002 also sends an ACCESS SUCCESS message to inform CU 1004 of which cell the UE has successfully accessed. At step 1018, UL user data is sent from UE 1001 to first DU 1002 and to CU 1004. Finally, when CU 1004 decides to release the source cell/DU, e.g., when UE moves away from the source cell, which is second DU 1003, at step 1091 the CU 1004 sends a UE CONTEXT RELEASE COMMAND message to the second DU 1003. At step 1092, second DU 1003 releases the UE context and responds to CU 1004 with a UE CONTEXT RELEASE COMPLETE message.

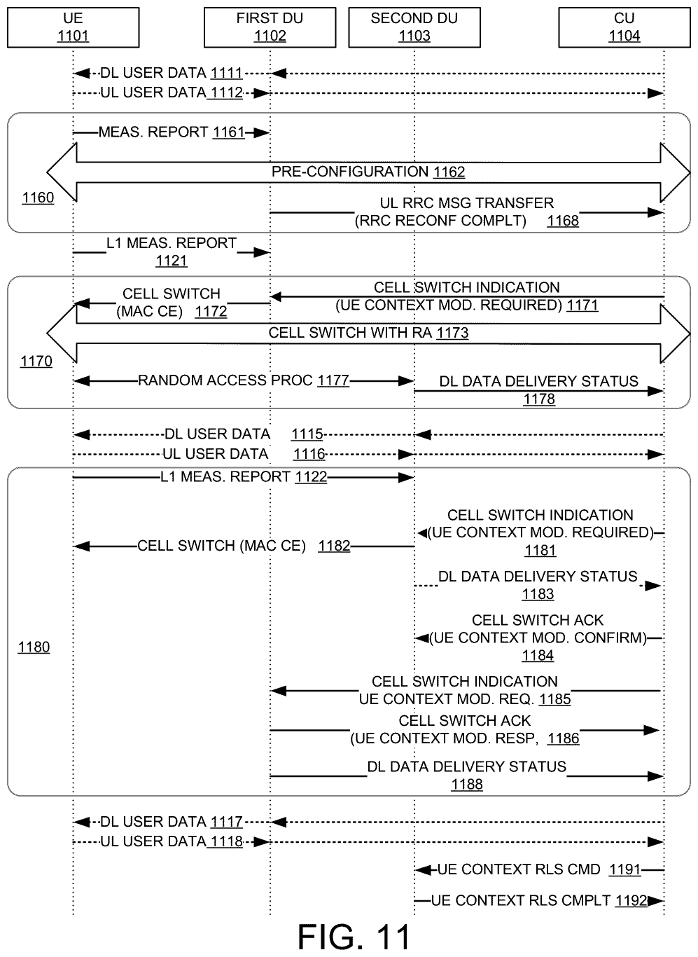

FIG. 11 illustrates exemplary overall flows of inter-DU inter-cell beam management with CU making cell switch decision with ping-pong effect in accordance with embodiments of the current invention. In one embodiment, to take advantage of the ping pong effect, the source DU will not release the UE context. The UE maintains source DU information, such as the TAG and keeps the associated TAT running. The RA procedure is skipped when switching back to the prior cell with valid information. For the case of CU making cell switch decision, the UE context will not be released by the source DU after UE switched to target cell. When TOS is short, UE may be switched back and forth between the two DUs, called the first DU and the second DU. At the very beginning, the UE is served by the first DU. The first DU is the source DU and the second DU is the target DU. Then UE is switched to the second DU. UE may be switched back to the first DU due to ping-pong effect. In this case, the second DU is the source DU and the first DU is the target DU.

UE 1101 is connected with the wireless network through a first DU 1102 and CU 1104. A neighboring cell is served with a second DU 1103. At step 1111, DL user data is transmitted through CU 1104 to first DU 1102 and to UE 1101. At step 1112, UL user data is sent from UE 1101 to first DU 1102 and to CU 1104.

Pre-configuration 1160 is provided first by network before the inter-cell beam management is executed. At step 1161, UE 1001 sends measurement reports to first DU 1102. Pre-configuration procedure 1162 is similar/the same as steps from 962-967 wherein pre-configuration is performed. At step 1168, first DU 1102 forwards the RRC configuration complete message to CU 1104 via an UL RRC MESSAGE TRANSFER message.

Cell Switch procedure 1170 is performed after the pre-configuration procedure 1160. In one embodiment, the CU makes the cell switch decision. At step 1121, UE 1101 starts performing L1 measurements and sending L1 measurement report for the candidate cells or the target cell to first DU 1102. At step 1171, CU 1104 detects the cell switch is fulfilled according to the L1 measurement report, then sends cell switch indication to first DU 1102. In one embodiment, the message is delivered by UE CONTEXT MODIFICATION REQUEST. CU 1104 sends a UE CONTEXT MODIFICATION REQUEST message to the first DU 1102 and indicates to stop the data transmission for the UE 1101. At step 1172, first DU 1102 sends the cell switch command to UE 1101 to indicate cell switch to the target cell. In one embodiment, the message is delivered by MAC CE. Cell switch with RA procedure 1173 is similar/the same as steps from 973-976. At step 1177, the RA procedure is performed at second DU 1103. At step 1178, second DU 1103 sends a Downlink Data Delivery Status frame to inform the CU 1104.

UE 1101 now switches to second DU 1103. At step 1115, Downlink packets, which may include PDCP PDUs not successfully transmitted in first DU 1102, are sent from the CU 1104 to the second DU 1103 and to UE 1101. In one embodiment, the second DU 1103 also sends an ACCESS SUCCESS message to inform CU 1104 of which cell the UE has successfully accessed. At step 1116, UL user data is sent from UE 1101 to second DU 1103 and to CU 1104.

A switch back procedure, the cell switch procedure 1180 is performed with ping-pong effect. In one embodiment, once the UE switches to second DU 1103, first DU 1102 does not release the UE context. At step 1122, UE 1101 sends L1 measurement reports to second DU 1103. At step 1181, CU 1104 detects the cell switch is fulfilled according to the L1 measurement report, then sends cell switch indication to second DU 1103. In one embodiment, the message is delivered by UE CONTEXT MODIFICATION REQUEST. CU 1104 sends a UE CONTEXT MODIFICATION REQUEST message to the second DU 1103 and indicates to stop the data transmission for the UE 1101. At step 1182, second DU 1103 sends the cell switch command to UE 1101 to indicate cell switch to the target cell. In one embodiment, the message is delivered by MAC CE. At step 1183, second DU 1103 also sends a Downlink Data Delivery Status frame to inform CU 1104 about the unsuccessfully transmitted downlink data to the UE. At step 1184, CU 1104 sends cell switch ACK to the second DU 1103 to indicate cell switch acknowledgement. In one embodiment, the message is delivered by UE CONTEXT MODIFICATION CONFIRM. At step 1185, CU 1104 sends a cell switch indication to first DU 1102. In one embodiment, the message is delivered by UE CONTEXT MODIFICATION REQUEST. At step 1186, first DU 1102 responds cell switch ACK to the CU 1104. In one embodiment, the message is delivered by UE CONTEXT MODIFICATION RESPONSE. Since first DU 1102 still has UE context and UE 1101 maintains first DU 1102 information, the RA procedure is skipped. At step 1188, first DU 1102 sends a Downlink Data Delivery Status frame to inform the CU 1104.

UE 1101 now switches back to first DU 1102. At step 1117, Downlink packets, which may include PDCP PDUs not successfully transmitted in second Du 1103, are sent from the CU 1104 to the first DU 1102 and to UE 1101. In one embodiment, the first DU 1102 also sends an ACCESS SUCCESS message to inform CU 1104 of which cell the UE has successfully accessed. At step 1118, UL user data is sent from UE 1101 to first DU 1102 and to CU 1104. Finally, when CU 1104 decides to release the source cell/DU, e.g., when UE moves away from the source cell, which is second DU 1103. At step 1191 the CU 1104 sends a UE CONTEXT RELEASE COMMAND message to the second DU 1103. At step 1192, second DU 1103 releases the UE context and responds to CU 1104 with a UE CONTEXT RELEASE COMPLETE message.

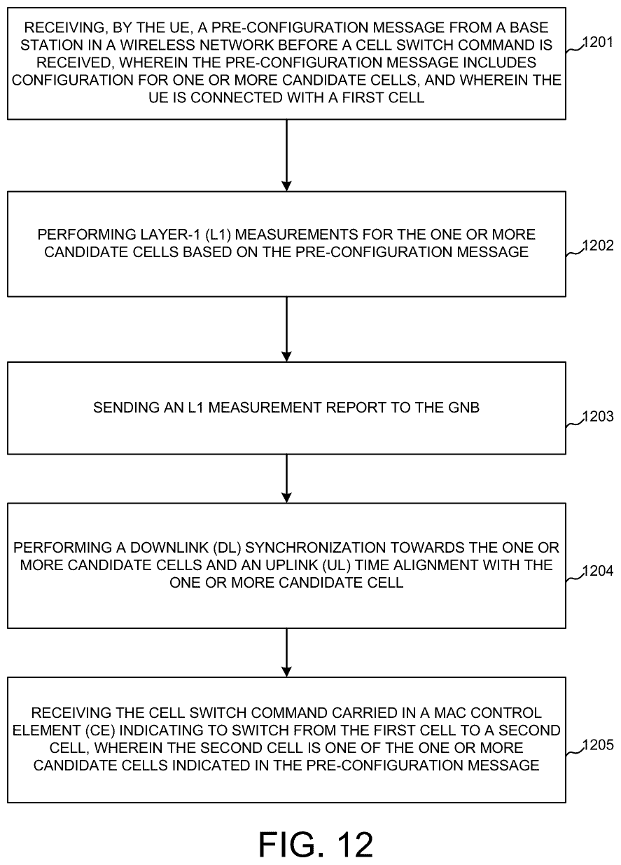

FIG. 12 illustrates an exemplary flow chart for the UE performing the control plane L1 ICBM with mobility in accordance with embodiments of the current invention. At step 1201, the UE receives a pre-configuration message from a base station in a wireless network before a cell switch command is received, wherein the pre-configuration message includes configuration for one or more candidate cells, and wherein the UE is connected with a first cell. At step 1202, the UE performs L1 measurements for the one or more candidate cells based on the pre-configuration message. At step 1203, the UE sends an L1 measurement report to the gNB. At step 1204, the UE, performing a downlink (DL) synchronization towards the one or more candidate cells and an uplink (UL) time alignment with the one or more candidate cell. At step 1205, the UE receives the cell switch command carried in a MAC control element (CE) indicating to switch from the first cell to a second cell, wherein the second cell is one of the one or more candidate cells indicated in the pre-configuration message.

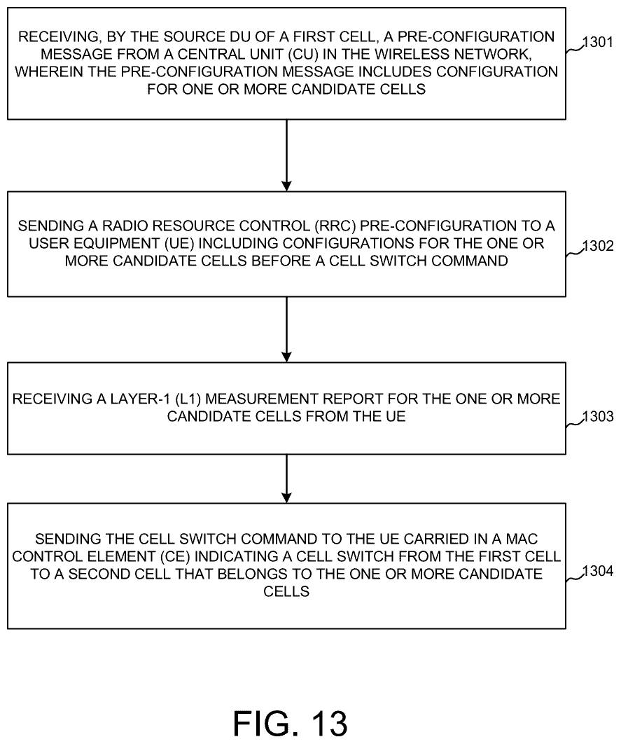

FIG. 13 illustrates an exemplary flow chart for the gNB/gNB-DU/base station performing the control plane L1 ICBM with mobility in accordance with embodiments of the current invention. At step 1301, the base station of a first cell receives a pre-configuration message from a central unit (CU) in the wireless network, wherein the pre-configuration message includes configuration for one or more candidate cells. At step 1302, the base station sends an RRC pre-configuration to a UE including configurations for the one or more candidate cells before a cell switch command. At step 1303, the base station receives an L1 measurement report for the one or more candidate cells from the UE. At step 1304, the base station sends the cell switch command to the UE carried in a MAC CE indicating a cell switch from the first cell to a second cell that belongs to the one or more candidate cells.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE), comprising:
receiving, by the UE, a pre-configuration message from a base station in a wireless network before a cell switch command is received, wherein the pre-configuration message includes configuration for one or more candidate cells, and wherein the UE is connected with a first cell;
performing layer-1 (L1) measurements for the one or more candidate cells based on the pre-configuration message;
sending an L1 measurement report to the base station;
performing a downlink (DL) synchronization towards the one or more candidate cells and an uplink (UL) time alignment with the one or more candidate cell; and
receiving the cell switch command carried in a MAC control element (CE) indicating to switch from the first cell to a second cell, wherein the second cell is one of the one or more candidate cells indicated in the pre-configuration message.

2. The method of claim 1, wherein the DL synchronization is performed upon receiving the pre-configuration message and before receiving the cell switch command carried in the MAC CE.

3. The method of claim 1, wherein the DL synchronization involves performing finer tracking and is performed based on the pre-configuration message.

4. The method of claim 1, wherein the UL time alignment is performed upon receiving the pre-configuration message and before receiving the cell switch command carried in the MAC CE.

5. The method of claim 1, wherein the UL time alignment is performed through a random access (RA) procedure towards the second cell.

6. The method of claim 1, further comprising: receiving a command from the wireless network to initiate the UL time alignment with the second cell or with the one or more candidate cells.

7. The method of claim 1, wherein the UL time alignment is performed upon detecting one or more conditions being satisfied based on the L1 measurement.

8. The method of claim 1, wherein the UL time alignment is performed without an RA procedure when the UE obtained a timing advance group (TAG) of the second cell and a timing advance timer (TAT) associated with the second cell is running.

9. A method for a source distributed unit (DU) of a base station in a wireless network, comprising:
receiving, by the source DU of a first cell, a pre-configuration message from a central unit (CU) in the wireless network, wherein the pre-configuration message includes configuration for one or more candidate cells;
sending a radio resource control (RRC) pre-configuration to a user equipment (UE) including configurations for the one or more candidate cells before a cell switch command;
receiving a layer-1 (L1) measurement report for the one or more candidate cells from the UE; and
sending the cell switch command to the UE carried in a MAC control element (CE) indicating a cell switch from the first cell to a second cell that belongs to the one or more candidate cells.

10. The method of claim 9, further comprising sending a cell switch request to the CU for a cell switch from the first cell for the UE.

11. The method of claim 10, wherein the cell switch request from the source DU to the CU is carried by UE CONTEXT MODIFICATION REQUIRED message, and wherein the source DU receives UE CONTEXT MODIFICATION CONFIRMED from the CU as a confirmation.

12. The method of claim 9, further comprising receiving a cell switch request from the CU for a cell switch from the first cell for the UE.

13. The method of claim 12, wherein the cell switch request from the CU is carried by UE CONTEXT MODIFICATION REQUEST message, and wherein the DU sends UE CONTEXT MODIFICATION RESPONSE to the CU.

14. The method of claim 9, further comprising forwarding the L1 measurement reports to the CU.

15. The method of claim 9, further comprising sending a Downlink Data delivery Status message to the CU, wherein the Downlink Data delivery Status message includes information about unsuccessful downlink data to the UE.

16. The method of claim 9 further comprising keeping UE context of the UE after the UE switched to the second cell.

17. A user equipment (UE), comprising:
a transceiver that transmits and receives radio frequency (RF) signal in a wireless network;
a pre-configuration module that receives a pre-configuration message from a base station in a wireless network before a cell switch command, wherein the pre-configuration message includes configuration for one or more candidate cells, and wherein the UE is connected with a first cell;
a layer-1 (L1) measurement module that performs L1 measurements for the one or more candidate cells based on the pre-configuration message;
a L1 measurement report module that sends an L1 measurement report to the base station;
a downlink(DL) sync module that performs a DL synchronization towards the one or more candidate cells; and
an uplink (UL) time alignment module that performs an UL time alignment with the one or more candidate cell; and
a cell switch module that receives the cell switch command carried in a MAC control element (CE) indicating to switch from the first cell to a second cell, wherein the second cell is one of the one or more candidate cells indicated in the pre-configuration message.

18. The UE of claim 17, wherein the DL synchronization is performed upon receiving the pre-configuration message and before receiving the cell switch command carried in the MAC CE.

19. The UE of claim 17, wherein the UL time alignment is performed upon receiving the pre-configuration message and before receiving the cell switch command carried in the MAC CE.

20. The UE of claim 17, wherein the UL time alignment is performed without an RA procedure when the UE obtained a timing advance group (TAG) of the second cell and a timing advance timer (TAT) associated with the second cell is running; otherwise, the UL time alignment is performed with an RA procedure.
